(19) United States
(12) Patent Application Publication
(10) Pub. No.: US 2011/0037428 A1
(43) Pub. Date: Feb. 17, 2011

(54) CONNECTION APPARATUS

(75) Inventors: Satoshi SAKAGUCHI, Nagoya (JP); Kenji KATO, Nagoya (JP); Tsukasa ITO, Nagoya (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/854,127

(22) Filed: Aug. 10, 2010

(30) Foreign Application Priority Data
Aug. 11, 2009 (JP) 2009-186299

(51) Int. Cl. H02J 7/00

(52) U.S. Cl. 320/107

(57) ABSTRACT

A connection apparatus to which an electronic device having a rechargeable power unit and capable of charging the rechargeable power unit in plural charge modes, can be connected, the connection apparatus including; a connector to which the electronic device can be connected and to which are connected an electric signal line used for exchanging electric signals with the electronic device and a power supply line used for charging the rechargeable power unit in the plural charge modes; and a signal output module for delivering to the connector a simulated reconnection signal for causing the electronic device to detect a temporary interruption of an electrical connection between the electronic device and the connector and a subsequent restoration of the temporarily interrupted electrical connection after a prescribed time interval, and a charge mode selection signal which the electronic device refers to, after having received the simulated reconnection signal, in selecting one of the charge modes.

### CROSS-REFERENCE TO RELATED APPLICATIONS

The present application claims priority to Japanese Patent Application No. 2009-186299 filed on Aug. 11, 2009, the disclosure of which is hereby incorporated by reference in its entirety.

### BACKGROUND OF THE INVENTION

1. Field of the Invention

The present invention relates to a connection apparatus to which is connected an electronic device that has a rechargeable power unit and is capable of charging the rechargeable power unit in plural charge modes.

2. Description of the Related Art

Portable electronic devices like PDAs and mobile phones, which each incorporate therein a rechargeable power unit such as a battery, have recently become more popular. Of such portable electronic devices are known those devices which can charge the batteries by selecting one of plural charge modes. When a portable electronic device of this kind is connected to a peripheral device for power supply, the device selects its own charge mode according to the type of the peripheral device, and initiates charging.

Known techniques for charging the batteries of portable electronic devices are disclosed in JP2000-354218A and JP2008-193783A, for example. JP2000-354218A discloses a charging device that varies the charging voltage depending on the type of digital camera. JP2008-193783A discloses a method for switching the current values of the charging current according to the status of the battery of a mobile phone.

These techniques, however, have shown little ingenuity in the way of switching the charge modes of a portable electronic device having plural charge modes. This issue is not limited only to portable electronic devices, but in general common to electronic devices with rechargeable power units.

### SUMMARY

An object of the present invention, which has been made to solve the problem described above, is to provide a technique capable of switching the charge modes of an electronic device automatically.

In order to solve the above mentioned problem, this invention can be embodied in the following modes of practice or examples of application.

### First Example Of Application

According to a first example of application, there is provided A connection apparatus to which an electronic device having a rechargeable power unit and capable of charging the rechargeable power unit in plural charge modes, can be connected, the connection apparatus including; a connector to which the electronic device can be connected and to which are connected an electric signal line used for exchanging electric signals with the electronic device and a power supply line used for charging the rechargeable power unit in the plural charge modes; and a signal output module for delivering to the connector a simulated reconnection signal for causing the electronic device to detect a temporary interruption of an electrical connection between the electronic device and the connector and a subsequent restoration of the temporarily interrupted electrical connection after a prescribed time interval, and a charge mode selection signal which the electronic device refers to, after having received the simulated reconnection signal, in selecting one of the charge modes.

When the electronic device is connected to the connector of the connection apparatus, the electronic device selects its own charge mode according to the status of the connection apparatus. Once the electronic device selects a charge mode, the selected charge mode is maintained until the electronic device is disconnected from the connector. Therefore, according to the first example of application of the invention, the electronic device can detect the temporary interruption of the electrical connection between the electronic device and the connector and the subsequent restoration of the temporarily interrupted electrical connection after the prescribed time interval. Thus, in the event of a change of the status of the connection apparatus, the charge mode of the electronic device may be switched automatically. Throughout this specification, the term “power unit” is meant to refers to batteries, secondary cells, capacitors, and similar rechargeable devices capable of repeated cycles of charge and discharge of electrical energy.

### Second Example Of Application

According to a second example of application of the present invention, there is provided the connection apparatus as described in the first example of application, wherein the connector has a terminal receiving the simulated reconnection signal from the signal output module, and the simulated reconnection signal is equivalent to the state where, for the prescribed time interval, a floating potential is developed at the terminal.

According to the second example of application of the present invention, the simulated reconnection signal may correspond to a high impedance developed between the terminal and a ground line, for the prescribed time interval.

The electronic device detects its connection with the connector on the basis of the state of the terminal of the connector of the connection apparatus. Therefore, according to the second example of application, the electronic device can detect the temporary interruption of the electrical connection between the electronic device and the connector and the subsequent restoration of the temporarily interrupted electrical connection after the prescribed time interval. As a result, the charge mode of the electronic device can be changed automatically.

### Third Example Of Application

According to a third example of application of the invention, there is provided the connection apparatus as described in the first or second example of application, wherein the connection apparatus can be connected to a computer, and the signal output module changes a level of the charge mode selection signal when power supply voltage supplied to the connection apparatus from the computer changes.

According to the third example of application, the charge mode of the electronic device can be changed in accordance with the level change in the power supply voltage supplied from the computer.

### Fourth Example Of Application

According to a fourth example of application of the present invention, there is provided the connection apparatus as described in the third example of application, wherein the signal output module outputs the simulated reconnection signal when power supply voltage supplied to the connection apparatus from the computer changes.

According to the fourth example of application, if the level of the power supply voltage supplied from the computer changes, the electronic device can detect the temporary interruption of the electrical connection between the electronic device and the connector and the subsequent restoration of the temporarily interrupted electrical connection after the prescribed time interval. As a result, the charge mode of the electronic device can be changed automatically.

### Fifth Example Of Application

According to a fifth example of application of the present invention, there is provided the connection apparatus as described in the first through fourth example of application, further comprising a charge mode indicating module for notifying a user of a type of the charge mode of the electronic device.

According to the fifth example of application, the user can detect the type of the charge mode of the electronic device.

The present invention can be realized in various modes of practice. Examples of such modes include a method and a device for connecting an electronic device and a computer; a connection system; an integrated circuit for accomplishing the function of such a method or device; a computer program; or a storage medium having the computer program recorded therein.

### BRIEF DESCRIPTION OF THE DRAWINGS

FIG. 1 illustrates the configuration of a cradle with USB hub function and peripheral devices according to an embodiment of the present invention;

FIG. 2 schematically shows the circuit configuration of the cradle;

FIG. 3 is a timing chart showing the waveforms of the signals appearing at several points within the cradle;

FIG. 4 is an illustration for explaining the state transitions of the cradle;

FIG. 5 illustrates the configuration of a cradle according to a second embodiment; and

FIG. 6 is a flowchart for explaining the operation of the cradle according to the second embodiment.

### DESCRIPTION OF THE PREFERRED EMBODIMENT

### Modes of Practice of the Invention

### A. First Embodiment

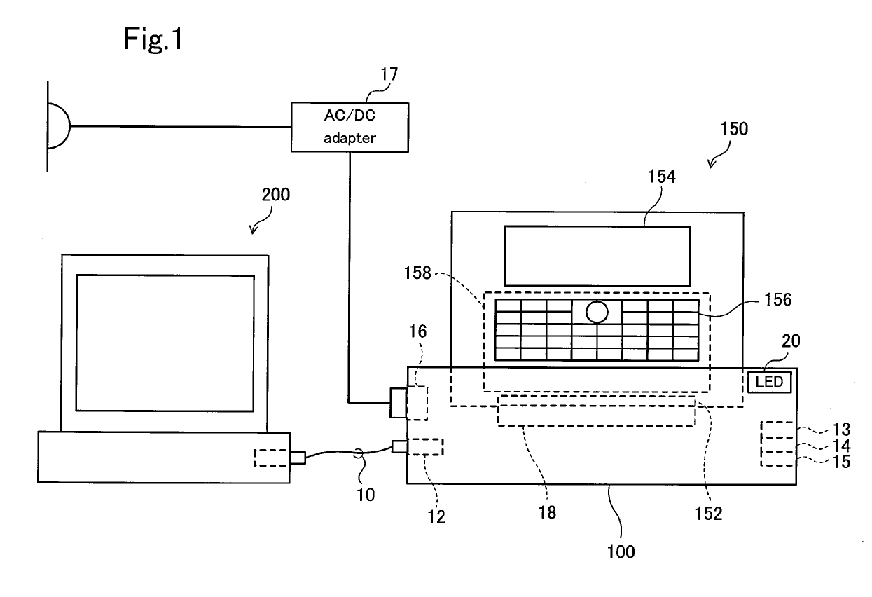

FIG. 1 illustrates the configuration of a cradle 100 with USB hub function and its peripheral devices according to an embodiment of the present invention. The cradle 100 is so designed that a personal digital assistant (PDA) 150 can be attached to it, and is connected to a computer 200 via a USB port 12 to which a USB cable 10 is connected. The cradle 100 has a connector 18 to be connected with the PDA 150, and USB ports 13, 14, 15 to be connected with USB peripheral devices. That is, the cradle 100 also functions as a USB hub. The cradle 100 is connected via a power terminal 16 to an AC/DC adapter 17 which supplies the cradle 100 with a DC power supply voltage Vc of 5V.

The PDA 150 has a display 154 and control buttons 156 on the front side thereof, and a battery 158 as the power unit inside it. The display 154 can display information that is stored in a storage medium (not shown) incorporated in the PDA 150. The user can operate the PDA 150 with the control buttons 156 while viewing information displayed on the display 154.

The PDA 150 is provided with a dedicated connector 152 on the lower periphery thereof, and when the PDA 150 is attached to the cradle 100, the connector 152 connects to the connector 18 of the cradle 100. Via the connector, the PDA 150 can exchange data with the computer 200 and also charge the battery 158 provided therein.

The PDA 150 can charge the battery 158 in plural charge modes. In the present embodiment, the PDA 150 has two charge modes, i.e. “Charge Mode A” and “Charge Mode B”. The “Charge Mode A” is a mode in which data communication with the computer 200 is enabled while the battery 158 is being charged. The “Charge Mode B”, on the other hand, is a mode in which data communication with the computer 200 is disabled although the battery 158 can be charged faster with current density greater than that in the “Charge Mode A”.

The cradle 100 has two power supply modes (“Power Supply Mode A” and “Power Supply Mode B”) which correspond to the two charge modes of the PDA 150, and can switch from one power supply mode to the other to charge the battery 158 of the PDA 150.

As will be discussed later, when the computer 200 is powered on and the cradle 100 is connected to the computer 200 via the USB cable 10, the cradle 100 enters the “Charge Mode A”. On the other hand, when the computer 200 is turned off or when the cradle 100 is not connected with the computer 200, e.g. when the USB cable 10 is unplugged from the USB port 12, the cradle 100 enters the “Charge Mode B”.

The cradle 100 is also furnished with an LED indicator 20 for indicating which power supply mode it is in. The LED indicator 20 may emit lights of different colors corresponding to the different power supply modes. This enables the user of the cradle 100 to ascertain the power supply mode of the cradle 100 from the color of the LED indicator 20. The LED indicator 20 may be omitted however.

When a peripheral device is connected to the connector 152, the PDA 150 determines whether the peripheral device is capable of data communications during charging, or capable of charging alone. In the present embodiment, when the PDA 150 is attached to the cradle 100, the PDA 150 determines the power supply mode of the cradle 100. The PDA 150 then sets its own charge mode according to the power supply mode of the cradle 100. In other words, if the PDA 150 is attached to the cradle 100 when the cradle 100 is in the “Power Supply Mode A”, the PDA 150 enters the “Charge Mode A”. On the other hand, if the PDA 150 is attached to the cradle 100 when the cradle 100 is in the “Power Supply Mode B”, the PDA 150 enters the “Charge Mode B”.

Once the PDA 150 establishes its own charge mode, the established charge mode is maintained until the connector 152 of the PDA 150 is disconnected from the power supply device even if the power supply mode of the power supply device subsequently changes. In other words, if the power supply device is in the “Power Supply Mode A” when the PDA 150 is connected to the power supply device, the PDA 150 enters the “Charge Mode A”. If the power supply mode of the power supply device subsequently switches from “Power Supply Mode A” to “Power Supply Mode B”, the PDA 150 maintains its own charge mode, i.e. “Charge Mode A”. Thus, in order to switch the charge mode of the PDA 150 from “Charge Mode A” to “Charge Mode B”, it is necessary for the user to disconnect the connector 152 of the PDA 150 from the connector of the power supply device, and then to reconnect the connector 152 of the PDA 150 with the connector of the power supply device. A similar procedure must be followed to switch the power supply device from “Power Supply Mode B” to “Power Supply Mode A”. Therefore, the cradle 100 according to the present embodiment is so designed as described below that when the power supply mode of the cradle 100 changes, the charge mode of the PDA 150 changes automatically without the user having to attach the PDA 150 to or detach it from the cradle 100.

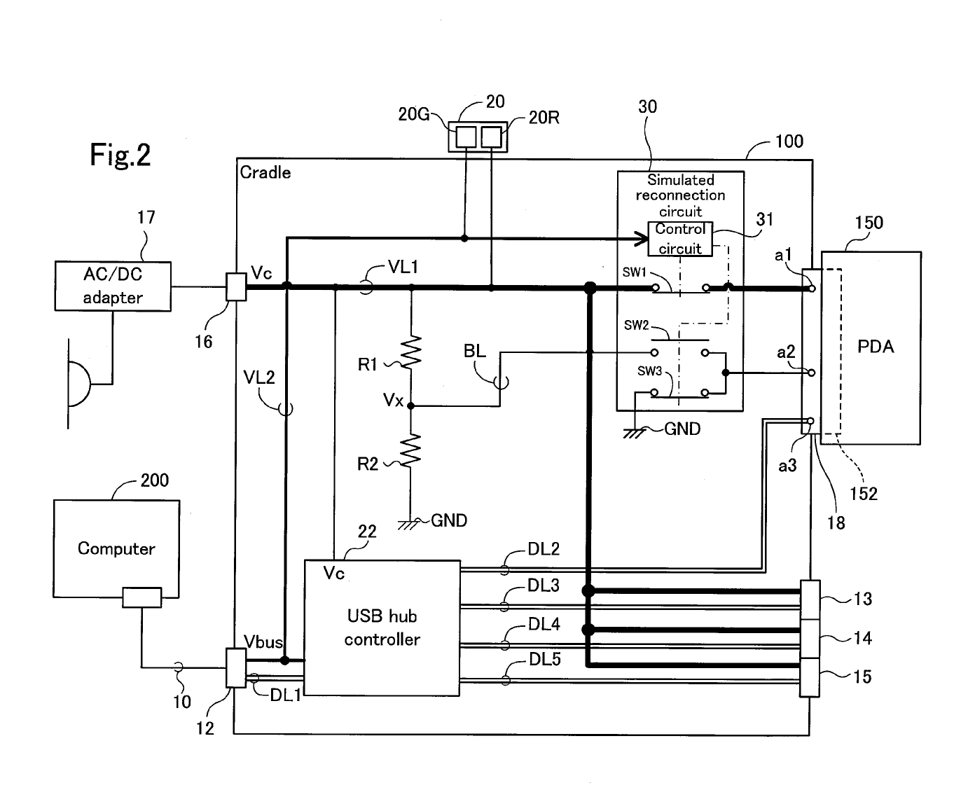

FIG. 2 schematically shows the circuit configuration of the cradle 100. The cradle 100 includes the USB ports 12, 13, 14, 15, the power supply terminal 16, the connector 18, the LED indicator 20, a USB hub controller 22 and a simulated reconnection circuit 30.

The cradle 100 is supplied with a power supply voltage Vc from the AC/DC adapter 17 through the power supply terminal 16, and the constituents of the cradle 100 are in turn supplied with the power supply voltage Vc as operating power through a power supply line VL1.

The USB hub controller 22 is connected to the USB port 12 via a USB power supply line VL2 and a USB data line DL1. The USB hub controller 22 sends the data received from the USB data line DL1, to the connector 18 and to the USB ports 13, 14, 15, through UBS data lines DL2 to LD5. Actually, a data line according to the USB standard is composed of a pair of signal lines, but for convenience the pair of signal lines is described as a single signal line. This convention applies also to the terminals connected to the ends of the data lines.

Two voltage-dividing resistors R1, R2 are connected in series between the power supply line VL1 and the ground GND. A branch line BL extends from the intermediate point between the voltage-dividing resistor R1 and the voltage-dividing resistor R2. Accordingly, the voltage Vx applied to the branch line BL is equivalent to the voltage obtained by stepping down the power supply voltage Vc in accordance with the ratio of the resistance values of the voltage-dividing resistors R1, R2. The branch line BL connects to a switch SW2 in the simulated reconnection circuit 30.

The description now turns to the connector 18 of the cradle 100. The connector 18 is provided with many terminals; of these, a power supply terminal a1, a peripheral device type identification terminal a2, and a data terminal a3 are discussed here.

The power supply terminal a1 is a terminal for supplying power to the PDA 150 (and the battery 158). As will be discussed later, the PDA 150 can determine whether a peripheral device is connected to the connector 152 by detecting whether the power source voltage is being applied to the power supply terminal a1 or whether the terminal a1 is at floating potential.

The peripheral device type identification terminal a2 is a terminal that allows the PDA 150 to identify the type of a peripheral device connected to the connector 152. To be concrete, when that terminal on the side of the connector 152 which corresponds to the peripheral device type identification terminal a2 is connected to the peripheral device type identification terminal a2 and when the peripheral device type identification terminal a2 is at the ground potential GND, the PDA 150 senses that a device capable of data communications in addition to charging (i.e. the cradle 100 in the “Power Supply Mode A”) is connected to the connector 152.

On the other hand, when the corresponding terminal of the connector 152 is connected to the peripheral device type identification terminal a2 and when the peripheral device type identification terminal a2 is at a prescribed voltage (in the present embodiment, voltage Vx), the PDA 150 senses that a device only capable of charging (i.e. the cradle 100 in the “Power Supply Mode B”) is connected to the connector 152.

If the cradle 100 is in the “Power Supply Mode A”, the data terminal a3 is used to transfer data between the computer 200 and the PDA 150.

A switch SW1 is provided between the power supply terminal a1 and the power supply line VL1. The switch SW2 is located between the peripheral device type identification terminal a2 and the branch line BL. Another switch SW3 is provided between the peripheral device type identification terminal a2 and the ground GND. That is, the switch SW2 and the switch SW3 are arranged in parallel with each other. Through the operation of the switches SW2 and SW3, the peripheral device type identification terminal a2 can be connected to either the branch line BL or the ground GND.

The simulated reconnection circuit 30 has a control circuit 31 therein, and the USB power supply line VL2 is connected to the control circuit 31. The control circuit 31 opens and closes the switches SW1 to SW3 according to the USB power supply voltage Vbus. The operations of the switches SW2, SW3 are discussed below while the operation of the switch SW1 is discussed later.

The control circuit 31 switches the connection of the peripheral device type identification terminal a2 according to the voltage level of the USB power supply voltage Vbus of the USB power supply line VL2. In other word, if the USB power supply voltage Vbus is being supplied, the control circuit 31 opens the switch SW2 and closes the switch SW3, thereby connecting the peripheral device type identification terminal a2 to the ground potential GND. The cradle 100 thus enters the “Power Supply Mode A” where the cradle 100 can send and receive data to and from the PDA 150 and power supply is also available.

On the other hand if the USB power supply voltage Vbus is not being supplied, the control circuit 31 closes the switch SW2 and opens the switch SW3, thereby connecting the peripheral device type identification terminal a2 to the branch line BL. The cradle 100 thus enters the “Power Supply Mode B” in which the cradle 100 cannot send and receive data to and from the PDA 150, but can enable fast charging.

While the difference between “Power Supply Mode A” and “Power Supply Mode B”, of the cradle 100 is simply that the peripheral device type identification terminal a2 is connected differently through switching. In this case, however, since the PDA 150 detects these two states as the connections to different types of power supply devices, these states are termed “Power Supply Mode A” and “Power Supply Mode B” for convenience.

The LED assembly 20 is composed of a red-light emitting element 20R that emits red light and a green-light emitting element 20G that emits green light. The red-light emitting element 20R is connected to the power supply line VL1, and the green-light emitting element 20G is connected to the USB power supply line VL2. Accordingly, when the cradle 100 is in the “Power Supply Mode B”, only the red-light emitting element 20R is lit, and the LED indicator 20 emits red light. On the other hand, when the cradle 100 is in the “Power Supply Mode A”, the green-light emitting element 20G is lit in addition to the red-light emitting element 20R, and the red and green colors mix so that the LED indicator 20 emits yellow light. Thus the user can distinguish between the power supply modes of the cradle 100 by the color emitted by the LED indicator 20. As will be discussed later, in the present embodiment, when the power supply mode of the cradle 100 changes, the charge mode of the PDA 150 also changes automatically. Thus, the user can distinguish between the charge modes of the PDA 150 by the color emitted by the LED indicator 20.

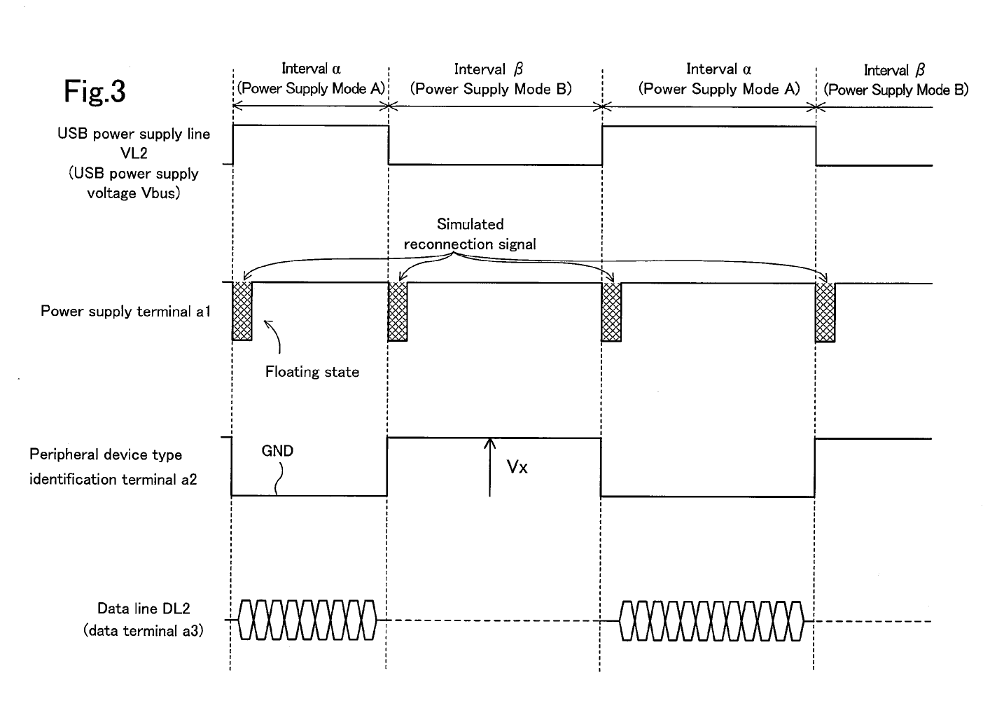

FIG. 3 shows various time-varying signal waveforms appearing in the circuit of the cradle 100. In FIG. 3 are shown the USB power supply voltage Vbus on the USB power supply line VL2, the signal that appears on the power supply terminal a1, the signal that appears on the peripheral device type identification terminal a2, and the signal that appears on the data terminal a3 at the end of the data line DL2.

During the time interval α for which the USB power supply voltage Vbus is at its H level, the computer 200 is powered on and the USB power supply voltage Vbus is applied to the cradle 100 via the USB cable 10. During this interval □, since the switch SW2 is open and the switch SW3 is closed, the ground potential GND appears on the peripheral device type identification terminal a2. That is, the cradle 100 is in the “Power Supply Mode A”. Also, during the interval □, data transfer takes place via the data terminal a3.

On the other hand, during the interval β, since the computer 200 is not powered on, or the USB cable 10 is not connected with the cradle 100, then the USB power supply voltage Vbus is not applied to the cradle 100. During this interval β, the switch SW2 is closed and the switch SW3 is open, so that the voltage Vx appears on the peripheral device type identification terminal a2. That is, the cradle 100 is in the “Power Supply Mode B”. During the interval β, data transfer does not take place at the data terminal a3.

When the connector 152 is connected to the connector 18 of the cradle 100 and when the PDA 150 receives the supply of power from the power supply terminal al (i.e. when the rising edge of the voltage at the power supply terminal a1 is detected), the PDA 150 detects the voltage level at the peripheral device type identification terminal a2, and decides whether the computer 200, which requests data communications, is connected to the data terminal 3a according to the voltage level at the peripheral device type identification terminal a2. As mentioned above, if the peripheral device type identification terminal a2 is at the ground potential GND, the PDA 150 decides that the cradle 100 is in the “Power Supply Mode A” and sets itself to the “Charge Mode A”. On the other hand, if the peripheral device type identification terminal a2 is at the voltage Vx, the PDA 150 decides that the cradle 100 is in the “Power Supply Mode B” and sets itself to the “Charge Mode B”.

However, as mentioned previously, once the PDA 150 establishes its own charge mode, the PDA 150 maintains the established charge mode until the connector 152 of the PDA 150 is unplugged from the connector of the power supply device, even if the power supply device changes its power supply mode. Accordingly, in order that the charge mode of the PDA 150 may be changed automatically in response to the change in the power supply mode of the cradle 100 without unplugging the connector 152 of the PDA 150 from the connector 18 of the cradle 100, the control circuit (FIG. 2) operates in the following manner.

The control circuit 31 detects the rising edge and falling edge of the USB power supply voltage Vbus, and opens the switch SW1 for a prescribed time interval after having detected these edges. The control circuit 31 then closes the switch SW1 after the prescribed time interval has passed. Consequently, during a prescribed time interval after the rising edge and the falling edge of the USB power supply voltage Vbus, the power supply terminal a1 is at a floating potential (assumes a floating state). Herein, the operation in which the switch SW1 is opened for a prescribed time interval and then closed is also termed “simulated reconnection operation”, and the floating state of the power supply terminal a1 for the prescribed time interval is also termed “simulated reconnection signal”.

From the voltage level at the power supply terminal a1, the PDA 150 decides whether a peripheral device is connected to the connector 152. Thus, if the power supply terminal a1 assumes the floating state, the PDA 150 decides that the connector 152 is unplugged from the connector 18 of the cradle 100. When the switch SW1 is then closed again after the prescribed time interval, the PDA 150 determines that the connector 152 is connected to the connector 18 of the cradle 100, and establishes its own charge mode in response to the power supply mode of the cradle 100.

In other words, if the power supply terminal a1 assumes the floating state and if the power supply voltage Vc reappears at the power supply terminal a1 after the prescribed time interval, this means that the power supply mode of the cradle 100 has already changed and the voltage level at the peripheral device type identification terminal a2 is also changed. Consequently, when the power supply mode of the cradle 100 changes, the charge mode of the PDA 150 is automatically changed without unplugging and plugging the PDA 150 from and to the cradle 100.

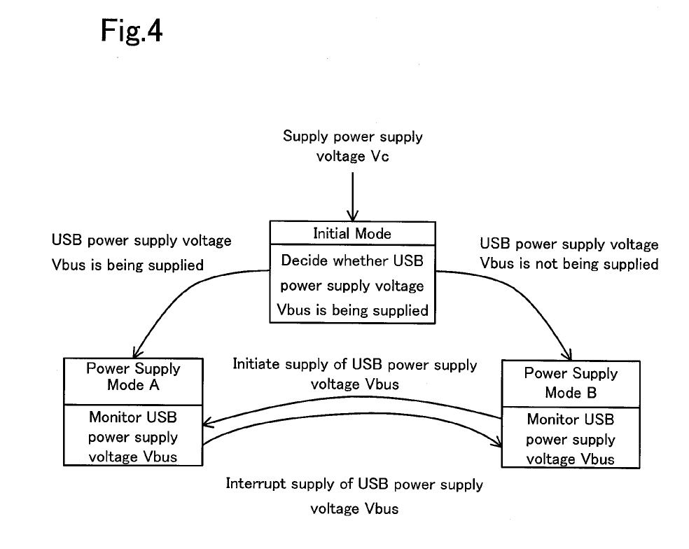

FIG. 4 illustrates the state transitions of the cradle 100. When the cradle 100 is supplied with the power supply voltage Vc from the AC/DC adapter 17, the cradle 100 enters the “Initial Mode”. In this Initial Mode, the switch SW1 is open. Upon entering the “Initial Mode”, the cradle 100 decides whether the USB power supply voltage Vbus is being supplied from the USB port 12. If the USB power supply voltage Vbus is being supplied, the cradle 100 shifts to the “Power Supply Mode A”. If the USB power supply voltage Vbus is not being supplied, the cradle 100 shifts to the “Power Supply Mode B”. After the cradle 100 has shifted from the “Initial Mode” to the “Power Supply Mode A” or “Power Supply Mode B”, the switch W1 is closed.

In the “Power Supply Mode A”, the cradle 100 checks whether or not the USB power supply voltage Vbus is being supplied, and if the USB power supply voltage Vbus is not being supplied, the cradle 100 shifts to the “Power Supply Mode B”. Immediately after the cradle 100 has shifted from “Power Supply Mode A” to “Power Supply Mode B”, the connection between the PDA 150 and the cradle 100 is temporarily interrupted and thereafter the cradle 100 supplies to the PDA 150 the signal (simulated reconnection signal) which causes the PDA 150 to detect the restoration of the temporarily interrupted connection. Thus, since the PDA 150 detects the temporary interruption of its connection with the cradle 100 and the subsequent restoration of the interrupted connection, the PDA 150 can set its own charge mode to the “Charge Mode B”.

In the “Power Supply Mode B”, on the other hand, the cradle 100 checks whether or not the USB power supply voltage Vbus is being supplied, and when the supply of the USB power supply voltage Vbus is initiated, the cradle 100 shifts to the “Power Supply Mode A”. Immediately after the cradle 100 has shifted from “Power Supply Mode B” to “Power Supply Mode A”, the cradle 100 supplies a simulated reconnection signal to the PDA 150. Thus, once the PDA 150 detects the temporary interruption of its connection with the cradle 100 and the subsequent restoration of the interrupted connection, the PDA 150 can set its own charge mode to the “Charge Mode A”.

In this way, according to the first embodiment, when the power supply mode of the cradle 100 is changed, the power supply terminal a1 assumes a floating state for a prescribed time interval. Accordingly, when the power supply mode of the cradle 100 is changed, the charge mode of the PDA 150 can be changed automatically without the user unplugging and reconnecting the PDA 150 from and to the cradle 100.

Consequently, even if the computer 200 is first turned off and then turned on while the PDA 150 remains connected to the cradle 100, data communication can be initiated between the PDA 150 and the computer 200 without the user unplugging and reconnecting the PDA 150 from and to the cradle 100.

On the other hand, if the computer 200 is first turned on and then turned off, the battery 158 of the PDA 150 can be quickly charged without the user unplugging and reconnecting the PDA 150 from and to the cradle 100, and the time required to charge the battery 158 can be markedly reduced. The user of the PDA 150 can thereby be provided with a cradle 100 having markedly improved ease of use.

### B. Second Embodiment

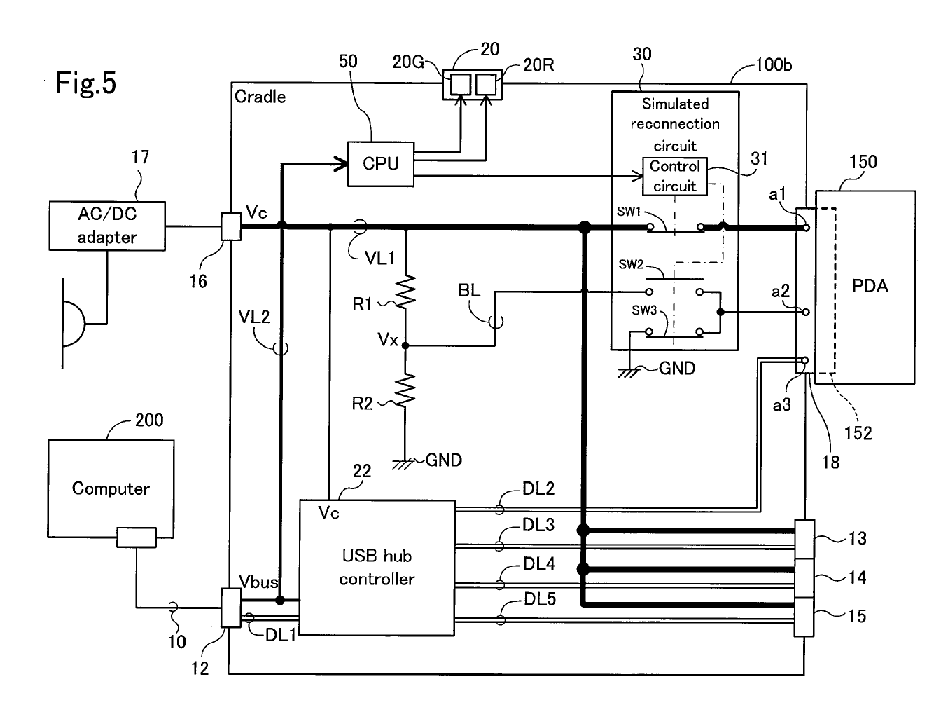

FIG. 5 schematically shows the configuration of a cradle 100b according to a second embodiment. The difference of this embodiment from the first embodiment shown in FIG. 2 is the provision of a CPU 50 which issues commands to the LED indicator 20 and the control circuit 31. The rest of the configuration is the same as in the first embodiment.

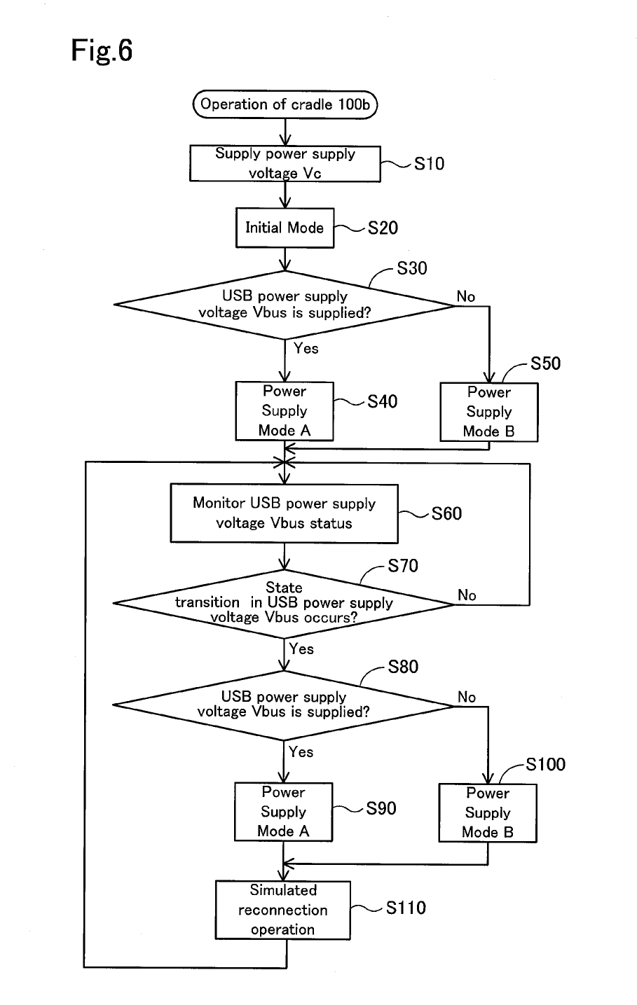

FIG. 6 is a flowchart for the operation of the CPU 50 of the cradle 100b. In Step S10, power supply voltage Vc is supplied to the cradle 100b. Upon being supplied with power supply voltage Vc, in Step S20, the CPU 50 outputs to the control circuit 31 a command to open the switch SW1, placing the cradle 100b in the “Initial Mode”.

In Step S30, the CPU 50 decides whether the USB power supply voltage Vbus is being supplied to the cradle 100b. If the USB power supply voltage Vbus is being supplied, the CPU 50 outputs to the control circuit 31 a command to connect the peripheral device type identification terminal a2 to ground potential GND, thereby setting the cradle 100b to the “Power Supply Mode A” (Step S40). On the other hand, if USB power supply voltage Vbus is not supplied, the CPU 50 outputs to the control circuit 31 a command to connect the peripheral device type identification terminal a2 to the branch line BL, thereby setting the cradle 100b to the “Power Supply Mode B” (Step S50).

After placing the cradle 100b in the “Power Supply Mode A” or “Power Supply Mode B”, the CPU 50 monitors the USB power supply voltage Vbus (Step S60). If a state transition occurs in the USB power supply voltage Vbus (Step S70: Yes), the CPU 50 decides whether the USB power supply voltage Vbus is being supplied to the cradle 100b (Step S80). On the other hand, if the state transition of the USB power supply voltage Vbus does not occur (Step S70: No), the CPU 50 returns to the step of monitoring the USB power supply voltage Vbus (Step S60).

In Step S80, if the USB power supply voltage Vbus is being supplied to the cradle 100b, the CPU 50 outputs a command to the control circuit 31 to set the cradle 100b in the “Power Supply Mode A” (Step S90). On the other hand, if the USB power supply voltage Vbus is not being supplied to the cradle 100b, the CPU 50 outputs a command to the control circuit 31 to set the cradle 100b in the “Power Supply Mode B” (Step S100).

Once the cradle 100b is set in the “Power Supply Mode A” or the “Power Supply Mode B”, in Step S110, the CPU 50 outputs to the control circuit 31 a command to carry out the simulated reconnection operation. Thus, the PDA 150 detects the temporary interruption of its connection with the cradle 100 and the subsequent restoration of the temporarily interrupted connection so that the PDA 150 can change its charge mode in response to the power supply mode of the cradle 100b established subsequent to the power supply mode transition thereof.

The CPU 50 can select between the LEDs in the LED indicator 20 to light up in response to the power supply mode of the cradle 100b. In the present embodiment, if the cradle 100b is in the “Power Supply Mode A”, the green-light emitting element 20G is lit, or if the cradle 100 is in the “Power Supply Mode B”, the red-light emitting element 20R is lit.

In this way, in addition to the fact that the cradle 100b of the second embodiment can have the same advantage as the first embodiment, the CPU 50 is involved in the decision of the power supply mode of the cradle 100 so that parameters such as, for example, the timings at which the switches SW1 to SW3 are opened and closed can be adjusted finely and that various different operating conditions can be set. Moreover, new functions can be added to the cradle 100b by updating the firmware.

### C. Modifications

The present invention is not limited to the embodiments described above, but may be practiced in various other ways without departing from the spirit thereof. Modifications such as the following ones are possible, for example.

### C1. Modification 1:

In the preceding embodiments, the LED indicator 20 includes the red and green LEDs to allow the user to differentiate between the power supply modes of the cradle 100b (and the charge modes of the PDA 150). However, the LEDs in the LED indicator 20 may have different combinations of colors. Alternatively, a single LED of a color may be used and continuously lit or flashed to enable the user to differentiate between the power supply modes of the cradle 100. Other light sources besides LEDs, such as EL (electroluminescence) elements, may also be used. The cradle 100 may also be provided with a voice generating module in place of the LED indicator 20, enabling the user to differentiate between the power supply modes of the cradle 100 (and the charge modes of the PDA 150) through voices.

### C2. Modification 2:

In the preceding embodiments, the cradle 100 is provided with the USB ports 13, 14, and 15, but these may be omitted. The present invention may be embodied as a connection device of cable form having a connector for the PDA 150 and a connector for the computer 200.

### C3. Modification 3:

In the preceding embodiments, the control circuit 31 opens and closes the switches SW1 to SW3 on the basis of the USB power supply voltage Vbus, but the switches SW1 to SW3 may be opened and closed on the basis of whether or not there is data transfer via the data terminal 3a, rather than on the basis of the USB power supply voltage Vbus.

To be concrete, if data is being transferred via the data terminal 3a, the control circuit 31 sets the cradle 100 in the “Power Supply Mode A”, or if data is not being transferred via the data terminal 3a, the control circuit 31 sets the cradle 100 in the “Power Supply Mode B”. In fact, when data transfer is initiated or it ceases, the control circuit 31 has only to output a simulated reconnection signal.

### C4. Modification 4:

In the preceding embodiments, the PDA 150 determines the type (the power supply mode) of the power supply device connected to the connector 152 on the basis of the voltage at the peripheral device type identification terminal a2. Alternatively, however, the PDA 150 may determine the type (the power supply mode) of the power supply device connected to the connector 152 on the basis of whether or not there is data transfer via the data terminal 3a. Further, the cradle 100 may be so designed that the voltage at the data terminal a3 takes different values according as data communication with the computer 200 takes place or not. Accordingly, the PDA 150 may be so designed as to determine the type (the power supply mode) of the power supply device connected to the connector 152 on the basis of the voltage value at this data terminal.

### C5. Modification 5:

In the preceding embodiments, the PDA 150 is described as an example of an electronic device having plural charge modes, but the electronic device may be any type of device such as, for example, a mobile phone, a portable game device, a digital camera, a portable television, a portable radio, or a portable music player, if it has plural charge modes.

### C6. Modification 6:

The circuit configurations described in the preceding embodiments may be composed of semiconductor circuits using switching elements such as transistors. Where the switches SW1 to SW3 are composed of transistors, the “simulated reconnection signal” corresponds to a high impedance developed between the peripheral device type identification terminal a2 and the ground for a prescribed time interval. The CPU 50, the USB hub controller 22, and the simulated reconnection circuit 30 in the second embodiment may be integrated in the form of a one-chip CPU or the like.

### C7. Modification 7:

In the preceding embodiments, the AC/DC adapter 17 is provided separately from the cradle 100, but the AC/DC adapter 17 may be integrated with the cradle 100.

### C8. Modification 8:

Part of the functions implemented through hardware in the preceding embodiments may instead be implemented through software, and conversely part of the functions implemented through software in the preceding embodiments may instead be implemented through hardware.

What is claimed is:

1. A connection apparatus to which an electronic device having a rechargeable power unit and capable of charging the rechargeable power unit in plural charge modes, can be connected, the connection apparatus comprising;
a connector to which the electronic device can be connected and to which are connected an electric signal line used for exchanging electric signals with the electronic device and a power supply line used for charging the rechargeable power unit in the plural charge modes; and
a signal output module for delivering to the connector a simulated reconnection signal for causing the electronic device to detect a temporary interruption of an electrical connection between the electronic device and the connector and a subsequent restoration of the temporarily interrupted electrical connection after a prescribed time interval, and a charge mode selection signal which the electronic device refers to, after having received the simulated reconnection signal, in selecting one of the charge modes.

2. The connection apparatus according to claim 1, wherein
the connector has a terminal receiving the simulated reconnection signal from the signal output module, and
the simulated reconnection signal is equivalent to the state where, for the prescribed time interval, a floating potential is developed at the terminal.

3. The connection apparatus according to claim 1, wherein
the connector has a terminal receiving the simulated reconnection signal from the signal output module, and
the simulated reconnection signal corresponds to a high impedance developed between the terminal and a ground line, for the prescribed time interval.

4. The connection apparatus according to claim 1, wherein
the connection apparatus can be connected to a computer, and
the signal output module changes a level of the charge mode selection signal when power supply voltage supplied to the connection apparatus from the computer changes.

5. The connection apparatus according to claim 4, wherein
the signal output module outputs the simulated reconnection signal when power supply voltage supplied to the connection apparatus from the computer changes.

6. The connection apparatus according to claim 1, further comprising a charge mode indicating module for notifying a user of a type of the charge mode of the electronic device.
